(19) United States
(12) Patent Application Publication
(10) Pub. No.: US 2020/0175566 A1
(43) Pub. Date: Jun. 4, 2020

(54) ADDING AND PRIORITIZING ITEMS IN A PRODUCT LIST

(71) Applicant: INTERNATIONAL BUSINESS MACHINES CORPORATION, Armonk, NY (US)

(72) Inventors: Michael Bender, Rye Brook, NY (US); Jeremy R. Fox, Georgetown, TX (US); Kulvir S. Bhogal, Forth Worth, TX (US)

(21) Appl. No.: 16/205,865

(22) Filed: Nov. 30, 2018

(51) Int. Cl. G06Q 30/06; G10L 15/22; G10L 15/18

(52) U.S. Cl. CPC G06Q 30/0633; G10L 2015/223; G10L 15/1815; G10L 15/22

(57) ABSTRACT

An adding and prioritizing system and method for products in a product list includes identifying a product using the natural language processing capabilities of a listening device, receiving an audible request to the listening device from a user to add the product to a product list, and prioritizing the product within the product list based on a command from the user to the listening device using the natural language processing capabilities of the listening device through an interactive dialogue with the user. The system and method also includes tracking changes made to the product list and metadata associated with products and changes within the product list, sharing the product list, the changes, and the metadata with at least one of a retailer or a manufacturer.

### TECHNICAL FIELD

This disclosure relates generally to systems and methods for identifying items presented through electronic commerce and sharing the identified items through different tiers of an online marketplace.

### BACKGROUND

With the increase in digital assistants and the growth of IoT-enabled devices throughout homes and in vehicles, users are more frequently utilizing these devices to make everyday tasks simpler. These devices spread beyond the simple use in mobile phones, such as mobile phone assistants and home-based beacons, into many different areas such as automotive and home product interfaces. Currently, these devices allow users to store relevant products or items in product lists by users manually adding products to the product list.

### SUMMARY

An embodiment of the present invention relates to a method, and associated computer system and computer program product, of adding and prioritizing items in a product list. One or more processors of a computer system identify a product using natural language processing capabilities of a listening device. The one or more processors receive an audible request to the listening device from a user to add the product to a product list. The one or more processors prioritize the product within the product list based on a command from the user to the listening device using the natural language processing capabilities of the listening device.

Another embodiment of the present invention relates to a method, and associated computer system and computer program product, of adding and prioritizing items in a product list. One or more processors of a computer system identify a similar product to a product located on a user's product list. The one or more processors receive confirmation from the user to substitute the product with the similar product. The one or more processors update the product list by removing the product and adding the similar product.

Another embodiment of the present invention relates to a method, and associated computer system and computer program product, of adding and prioritizing items in a product list. One or more processors of a computer system track changes made to a product list and metadata associated with products and changes within the product list. The one or more processors share the product list, the changes, and the metadata with at least one of a retailer or manufacturer, wherein the retailer and manufacturer are chosen based on at least one of the location of the user or the products involved in the change to the product list.

### BRIEF DESCRIPTION OF THE DRAWINGS

Advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1 shows a computer system, according to some embodiments of the present invention;

FIG. 2 illustrates the general flow of information from various information sources to a central storage system according to an embodiment of the present invention.

FIG. 3 illustrates a flowchart of steps performed to receive information and prioritize the received information according to an embodiment of the present invention.

FIG. 4 illustrates a flowchart showing the steps utilized by the present invention to share data collected by the system with a retail or other supplying entity according to an embodiment of the present invention.

FIG. 5 illustrates a flowchart showing the steps utilized by the present invention to share data collected by the system with a manufacturer entity.

FIG. 6 depicts a block diagram of components of a computing device, in accordance with an illustrative embodiment of the present invention.

FIG. 7 depicts a cloud computing environment, according to an embodiment of the present invention.

FIG. 8 depicts abstraction model layers, according to an embodiment of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

The widespread availability of computer devices capable of communicating with each other through communication networks (e.g., the Internet) facilitates online shopping and electronic commerce (“e-commerce”). For example, consumers can shop for items (e.g., products and/or services) in online marketplaces. Purchased products can be shipped directly to the consumers. For many consumers, online shopping can be more convenient and more efficient than visiting brick-and-mortar stores in person.

The availability of networked computer devices also facilitates the sharing of ratings and reviews of items by consumers. For example, many online marketplaces permit users to submit ratings and reviews of items, which other users can view when deciding whether to purchase the items.

One of the capabilities of these new devices is to store a “favorites” list of items that a user may want to order in the future. These devices are also in locations where individuals are hearing content (e.g. a television) or seeing content (e.g. a billboard); the marketing of products may persuade a user to add something to a “favorites” list. The challenge becomes how to handle prioritizing against or replacing similar items in the list.

Present methods do not provide for an easy or efficient way to quickly add new products to a product list and to quickly prioritize the product within the product list. Present methods only allow for a user to add an item to a list via a verbal command. Moreover, manufacturers and retailers value user interests and trends. Existing technology fails to allow for an easy and efficient way for retailers and manufacturers to access this data.

Thus, there is a need for methods and system for adding and prioritizing products in a product list that improves the deficiencies known in the art. The present invention will significantly improve the shopping and ordering process for users. The present invention, when practiced, will improve the technology by allowing for a listening device to automatically identify and classify products in everyday life without having the user manually input the product. Moreover, embodiments of the present invention will improve the technology by utilizing the natural language processing capabilities of licensing devices to have an interactive dialogue with users to quickly and easily prioritize a product list. Further, the present invention will result in a vast improvement of the marketing abilities of companies as the systems and methods disclosed will share products which are increasing in popularity, changes in users' product lists and the marketing tool which prompted the change, allowing for companies to optimize their marketing budget and strategy.

There are multiple ways of identifying what is being presented in a commercial, movie or television show as it relates to commercial products. The commercial item can be identified by image or text. The same methods can be used to identify content from a billboard through the use of a personal mobile device or a camera linked to a car. Once a commercially available product has been identified, the present invention allows for an audible request to add the product to a favorites list and to categorize the product (e.g. dog food vs laundry detergent). Many times, the addition of one product would supplement an existing product in the referenced product or shopping list. The present invention leverages the NLP (natural language processing) capabilities of listening devices (standalone, wearable or attached to a car) to have an interactive dialog to properly place the item within your product list.

The foregoing Summary, including the description of motivations for some embodiments and/or advantages of some embodiments, is intended to assist the reader in understanding the present disclosure, and does not in any way limit the scope of any of the claims.

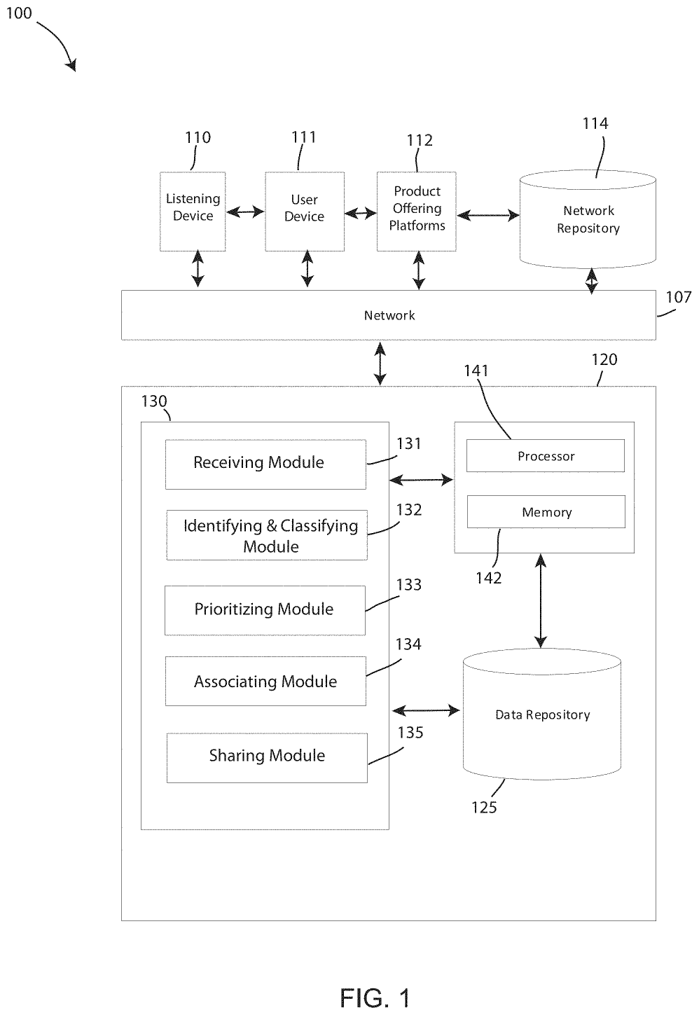

Referring to the drawings, FIG. 1 depicts a block diagram of a system for adding and prioritizing items in a product list through a listening device 100, in accordance with embodiments of the present invention. Embodiments of the system for adding and prioritizing items in a product list through a listening device 100 can be described as a system for identifying commercially available products, adding the product to a product list or favorite list through an audible command to a listening device, classifying the product, and utilizing natural language processing to have an interactive dialog to properly place the item within the product/favorite list. It should be understood that a product list or favorite list is simply a list containing a number of products and can be described as a shopping list, a cart, an inventory, a wish list, and the like. The system for adding and prioritizing items in a product list through a listening device 100 can also be describe as a system for allowing manufactures and retailers to optimize their business processes by receiving changes in the product/favorite list. The system for adding and prioritizing items in a product list through a listening device 100 can obtain product information and audible commands and feedback from a listening device 110 or a user device 111. The system for adding and prioritizing items in a product list through a listening device 100 can add, adjust, and share changes to a product list based on product information received and audible commands given to the listening device 110.

Embodiments of the listening device 110 can include a computing device, a personal digital assistant, an enterprise digital assistant, a virtual assistant, and the like. The listening device 110 can be any device capable of listening to and understanding natural language voice commands and completing or performing tasks for users. While only one listening device 110 is shown in FIG. 1, it should be understood that the number of listening devices 110 connecting to the computer system 120 over the network 107 may vary from embodiment to embodiment. For example, a user may own multiple virtual assistants throughout his/her home, car, and/or office. Each virtual assistant can be configured to send and receive information to and from the computer system 120. The listening device 110 can be configured to listen to product information received from the product offering platforms 112 or user device 111, store the products in a product list, receive audible commands from users, and complete or perform tasks based on the audible commands. In one embodiment, the system for adding and prioritizing items in a product list through a listening device 100 activates, stores, and records the information received and transmitted by the listening device 110, with permission from users. In other embodiments, the recording and classification can be done through an opt-in/opt-out registration wherein users may opt-in or opt-out any time through a command to the listening device 110.

Embodiments of the user device 111 can include a computing device, such as a computer, laptop, smartphone, or tablet device, associated with or operated by users. The user device 113 may also be a wearable device such as a smart watch or the like. The user device 113 may run various applications that contain data about the user. The user device 111 can be communicatively coupled to a computer system 120 over a network 107. The user device 111 may include one or more hardware components for sending/receiving geolocation data of the user device 111. The user device 111 may include a number of input devices for providing or inputting information to computer system 120 over the network 107. For example, the user device 111 may include a Bluetooth system, or other transmitting system configured to provide information from the user device 111 into the system. Input devices of the user device 111 may include an accelerometer, a gyroscope, a GPS system, biometric sensor, a wearable sensor, a microphone, a peripheral device, or the like.

Information provided by the user device 111 to the computer system 110 can include product information, shopping information, browsing history, user information, and the like. For example, users may utilize a user device 111 to browse for products online. The user device 111 may transmit product information displayed while users are browsing to the computer system 120. The user device 111 may also transmit user information data which may include personal preferences, likes/dislikes, dietary information, user interests, transaction history, internet history, social media data and other data pertaining to users' actions and history while using the user device 111.

Embodiments of the product offering platforms 112 can include any platform on which products are offered. Examples of product offering platforms 112 include commercials, advertisements, movies, television shows, billboards, newspapers, pamphlets, online marketplaces, websites, in-store displays, or any other platform on which products are displayed, discussed, or offered for sale. Product information displayed or discussed on the product offering platforms 112 may be transmitted to the computer system directly over network 107 or through the listening device 110 or user device 111. For example, the listening device 111 may listen to an advertisement discussing a product on television. The advertisement would be the product offering platform 112. The listening device 110 would listen to the advertisement and then transmit the product information in the advertisement to the computer system 120.

A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computer system 120 and the listening device 110, a connection to one or more network accessible knowledge bases containing information of one or more users, network repositories 114 or other systems connected to the network 107 that may be considered nodes of the network 107. In some embodiments, where the computer system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user data sent by the listening device 110 and/or user device 111 to generate both historical and predictive reports regarding product information, favorites, product lists, buying patterns and the like. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Embodiments of the computer system 120 may include a receiving module 131, an identifying and classifying module 132, a prioritizing module 133, an associating module 134, and a sharing module 135. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

Embodiments of the receiving module 131 include one or more components of hardware and/or software program code for obtaining, retrieving, collecting, or otherwise receiving information from the system for adding and prioritizing items in a product list through a listening device 100. In one embodiment, the receiving module 131 is configured for receiving information directly from the listening device 110 and the user device 111. Embodiments of the listening device 110 and the user device 111 may be components of the computer system 120, or they may be external to the computer system 120 and connected to the computer system 120 over network 107. The listening device 110 and the user device 111 can be configured to transmit all information they have collected to the computer system 120. For example, the receiving module 131 may receive product information the listening device 110 has listened to, commands received from users, or product information and lists stored in the listening device 110. Further, the receiving module 131 may be configured to receive product information, shopping history, browsing history, favorites, preferences, or other user information data from the user device 111.

The receiving module 131 can also be configured to receive new products to be added to a products list or a favorites list. For example, users may give an audible command to a listening device 110 to add a recently viewed product to the users' product list. The receiving module 131 then receives this command and product from the listening device 110 and adds the product to the users stored product list. The product list may be stored in the data repository 125, which is described in more detail below.

Embodiments of the identifying and classifying module 132 include one or more components of hardware and/or software program code for identifying products and classifying the products based on product information received by the computer system 120. Embodiments of the identifying and classifying module 132 may refer to configurations of hardware, software program code, or combinations of hardware and software programs, capable of analyzing data received from the listening device 110, the user device 111 and/or the product offering platforms 112. The identifying and classifying module 132 can be configured to identify products based on information received. The identifying and classifying module 132 utilizes natural language processing techniques for identifying and classifying products in audible product offering platforms 112 or commands from users. Further, the identifying and classifying module 132 utilizes visual/object recognition techniques for identifying and classifying products in non-audible product offering platforms 112. Moreover, the identifying and classifying module 132 can utilize a combination of natural langue processing and visual/object recognition techniques for identifying and classifying products. For example, the listening device may listen to an advertisement for a dog food. The identifying and classifying module 132 can analyze and detect which brand and the specific product being offered in the advertisement based on the words of the advertisement, which are captured by the listening device 110 or the user device 111.

The identifying and classifying module 132 can also be configured to classify a product after it has been identified. For example, the identifying and classifying module 132 may identify a product as XYZ' sadult dog food. The identifying and classifying module 132 may then determine if the product is within a known category. The known categories may be stored in the data repository 125. If there is a known category, the identifying and classifying module 132 will automatically classify that product into the known category. If there is no known category for the product, the identifying and classifying module 132 can be configured for retrieving or requesting a new category. The new category may be retrieved from an external data storage source, such as the network repository 114, or it may be manually entered by users via the listening device 110 or the user device 111.

After a product has been identified and classified, the identifying and classifying module 132 can be figured to add, replace, or remove products from users' product lists. For example, a user may give instruction to the listening device 110 to add a new dog food to the product list. The identifying and classifying module 132 can be configured to add the new product and inquiry, through the listening device 110, whether the old dog food product should remain on the product list or be removed. If the user responds to the listening device 110 that the old dog food product should be removed, then the identifying and classifying module 132 will remove the old dog food product from the product list and store the new list with the new dog food product in the data repository 125.

Still referring to FIG. 1, embodiments of the prioritizing module 133 include one or more components of hardware and/or software program code for prioritizing products contained in a product list. Embodiments of the prioritizing module 133 may refer to configurations of hardware, software program code, or combinations of hardware and software programs, capable of analyzing data received from the listening device 110, and/or the user device 111 to prioritize or rank products which are in the same classification or category in a product list. The prioritizing module 133 can be configured to receive user commands from the listening device 110 or the user device 111 as to which product should be prioritized. For example, a user may add a new cereal to a product list and indicate that they do not want to remove or replace other cereals which are currently on the product list. The prioritizing module 133 may then prompt the listening device to inquire as to where the new cereal should be ranked or prioritized in relation to the old cereals previously on the product list. The listening device 110 may then relay the user response received and the prioritizing module 133 can then prioritize or rank the new cereal according to the user response.

Additionally, the prioritizing module 133 can be configured for automatically prioritizing or ranking products. The prioritizing module 133 can utilize shopping history or buying patterns to determine which products a specific user buys most frequently. For example, product A and product B have been classified as being in the same category of product and a user has initial prioritize product A over product B because the envision themselves purchasing product A more frequently. However, over time, the prioritizing module 133, based on information received from the user device 111 or listening device 110, may determine that the user is now consistently purchasing product B more frequently than product A. The prioritizing module 133 is then enabled to re-rank these products to prioritize product B over product A, without any prompting by the user. In this scenario, the prioritizing module 133 may confirm the change in priority with the user prior to automatically re-prioritizing the products.

Embodiments of the associating module 134 include one or more components of hardware and/or software program code for associating products to a specific user's product list, or associating products to different users within a single product list. The associating module 134 can be configured for automatically associating the product to a user based on which user is using the listening device 110 or user device 111. For example, in one embodiment a user may have a user name or login to a user device 111 or there may be multiple user devices 111, each being associated to a different user. When a product is added using one of the user devices 111, the associating module 134 can automatically associate the product to a specific user based on which user the user device 111 is currently associated to. In another embodiment, the listening device 110 and associating module 134 can be configured to automatically detect the user based on voice analysis. For example, the listening device 110 may receive an audible command from a user. The listening device 110 and associating module 134 may then analyze the voice giving the audible command and associate the voice with a known prior user of the listening device 110.

The associating module 134 can also be configured to prompt or request users to associate the product with a user in an interactive dialogue. For example, a family including a father, mother, daughter and son are users of the system for adding and prioritizing items in a product list through a listening device 100. The family has a listening device 110 in their home. While watching an advertisement for a new clinical strength shampoo on television, the father audibly commands the listening device 110 to “add that shampoo to my product list.” The listening device 110 replies that it is adding theclinical strength shampoo to the product list and asks the father if shampoo is the correct classification for this product (this is done by the identifying and classifying module 132 as described above). The father responds to the listening device 110 that shampoo is the correct classification. The listening device 110, prompted by the associating module 134, then asks the father if this product is the father's, mother's, daughter's, or son's shampoo. The father responds to the listening device 110 that the shampoo is the father's. The associating module 134 then associates the new shampoo with the father on the family's product list.

With continued reference to FIG. 1, embodiments of the sharing module 135 include one or more components of hardware and/or software program code for sharing preferences and preference changes with suppliers and manufacturers. The sharing module 135 can be configured to share preferences or product lists with suppliers of products. For example, the sharing module can share that a new product has been added to a user's product list. The supplier may receive data from a plurality of users' sharing module 135 showing that this new product has been added to a number of user's product lists, indicating that this new product may be popular or high selling. The supplier can then increase their supply of the product from a distributor. The supplier may then also, knowing that the new product is popular, set up displays in strategic locations within the supplier's brick and mortar locations to increase sales of the new product.

The sharing module 135 can also be configured to share preference changes and metadata with manufacturers. The sharing module 135 can share both that a user has changed preferences or priority within a category of product and the metadata associated with that change. The metadata is any data surrounding a user's request to add or change a product, and can be described as what prompted or influenced the change or terms and conditions around when a user would order the product. Examples of metadata include the commercial, advertisement, billboard, website, display, or other marketing means for a product. For example, a user may prompt a change in their product list to make product B their new favorite of preferred product in a category, changing from product A. The identifying and classifying module 132, as described above, will know that the user made this change after listening to a specific commercial for product B on television. This commercial will be stored as metadata associated with the change from product A to product B. The sharing module 135 can then share this change and associated metadata with the manufacturers of products A and B. This sharing will allow the manufacturer of product A to know that they are losing customers to a competitor and may need to increase marketing. It will also know the manufacturer of product B to know the specific advertisement is effective in changing customer interest in their product. The sharing of preference changes and associated metadata allows for manufacturers to optimize their marketing budget and strategy.

Referring still to FIG. 1, embodiments of the computer system 120 are equipped with a memory device 142 which may store product lists, product information, user preferences, categories of products, user information, metadata, and all other data required to complete the tasks as described above and a processor 141 for implementing the tasks associated with the system for adding and prioritizing items in a product list through a listening device 100.

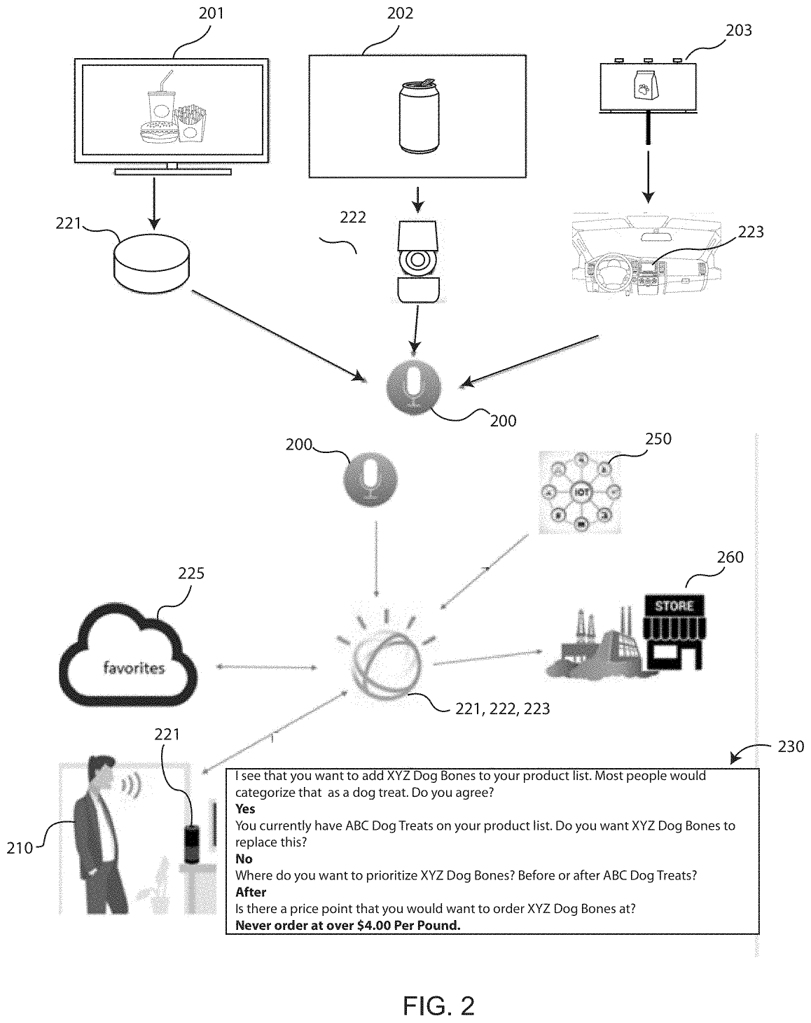

With reference to FIG. 2, the general flow of information is illustrated according to an embodiment of the present invention. According to an embodiment of the present invention, content is captured from at least one of a television show (201), movie (202) or a mobile camera (203). Of course, other sources of content are envisioned by the present invention and these examples are provided only for explanatory purposes only. According to the invention, a user 210 requests that the content 201, 202, 203 be added to their favorites list by voice command directed to one of the smart devices and/or computers 221, 222, 223. The smart device; e.g., listening device 221, 222, 223, communicates with the system 200 to capture the content for analysis at a central computing system 250. All audio and videos feeds are captured and analyzed to identify the product(s) at issue in the content 201, 202, 203. The system 200 captures the current favorites list 225 associated with the user 210, which favorites list is going to be updated. The system 200, via listening device 221, has an interactive discussion or chat 230 with the user 210 through the listening device 221, 222, 223 to add the appropriate priority and metadata around the item in the favorites list 225. Information related to the favorites list as well as its priority and the metadata around the items/content may then be made available to manufacturers and retailers 260 as will be described in more detail below.

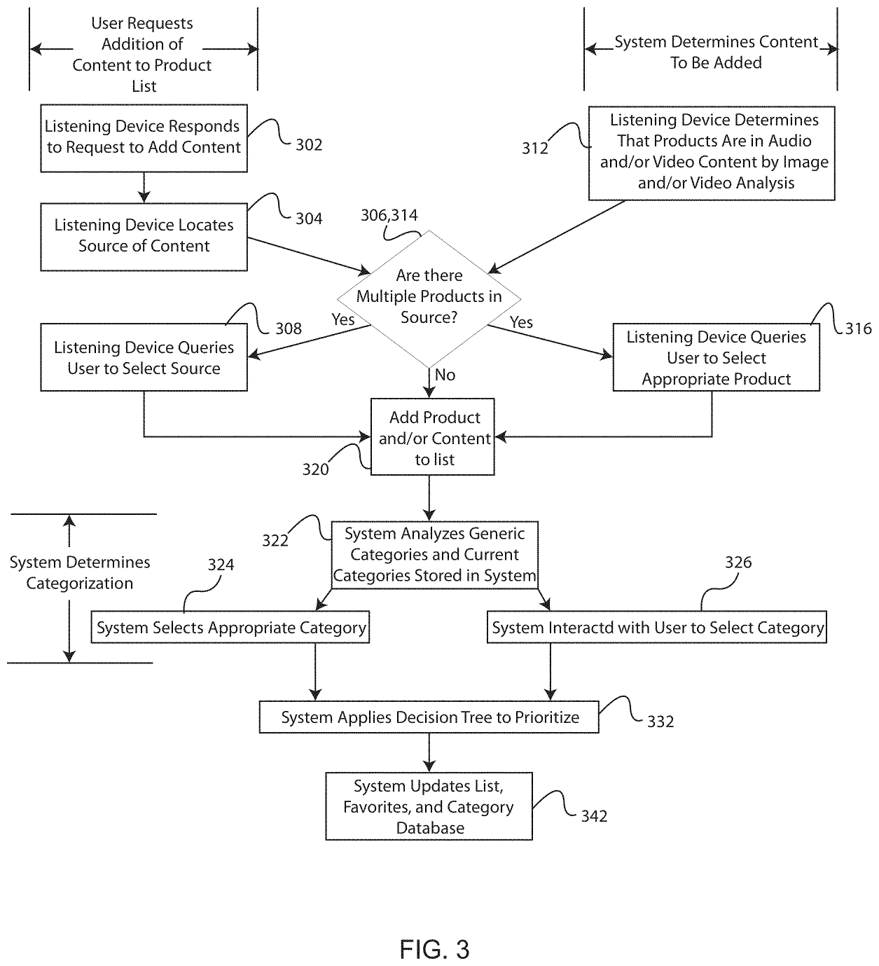

FIG. 3 illustrates a flowchart of steps performed to receive information and prioritize the received information according to an embodiment of the present invention. The embodiment of FIG. 3 will focus on information received through a listening device, audio device and/or video device; however, it will be understood by those of skill in the art that information may be received from various data sources in accordance with this invention. At step 302, the listening device 221 responds to a request to add content to the system 200; e.g., the user's shopping cart or product list. At step 304, the system 200 via the listening device locates a source of content for the content to be added. At step 306, the system determines whether there are multiple sources for the specific content at issue. If multiple sources exist, then the system will query the user at step 308 to select a preferred source of the content. If multiple sources do not exist, then the system 200 will add the content to the list. Steps 302-308 may be categorized as a grouping of steps to add additional items or content to a user's product list through a proactive device that prompts or requests the user to add items or content using an interactive dialogue.

At the next phase of the method set forth, the system 200 will analyze products being processed by the system through audio or video analysis apart from the proactive prompt or request by the listening device. At step 312, the listening device (or other data processing device) determines that products and/or service are contained in the audio and/or video content by video and/or audio analysis. Next, the system 200 will determine whether there are multiple sources for the specific content at step 314. If multiple sources exist, then the system will query the user at step 316 to select a preferred source of the content. If multiple sources do not exist, then the system 200 will add the content to the list. Steps 312-316 may be categorized as a grouping of steps to determine products or content to be added to a user's product list or shopping cart through visual and/or audio analysis.

At the next phase of the method set forth, the system 200 will determine a categorization for products being added by the system at steps 302-316. At step 322, the system analyzes generic categories and current categories stored in the system. Next, the system 200 at step 324 will select the appropriate category for a particular product or content. If the system 200 determines that there are multiple categories for a particular item or content, then the system 200 at step 326 will query the user at step 316 to select a preferred category for the content. The system looks up the current products in the product list to determine current categories. More specifically, the system 200 looks up generic categories in a public table. Then, using natural language processing (NLP), the system 200 selects the appropriate categories and interacts with the user to finalize the appropriate category or add a new one. The same process can continue to add a product to multiple categories (e.g. detergent in home and vacation home).

After the system 200 has categorized a particular item or content, then the system 200 will apply at step 332 a decision tree to prioritize the item or content. A specific example of the decision tree will be explained in further detail below. However, the system 200 at step 332 may follow several different protocols to prioritize the item including again prompting the user to assist with prioritization. More specifically, the system queries the products in the category that has been determined. If the product already exists, the system goes through a decision tree to question the user to determine the appropriate priority. The system uses a decision tree to prompt for additional metadata related to the product that an individual may choose to configure (e.g. try it once, only purchase at a price point, buy secondary product if first one is not available)

Lastly, at step 342, the system 200 will update the favorites and the category database based on the newly added items or content determined via steps 302-316. The system 200 may use a decision tree to prompt for additional metadata related to the product that an individual may choose to configure (e.g. try it once, only purchase at a price point, buy secondary product if first one is not available). After the appropriate information has been captured, the appropriate favorites and category database is updated. It is noted that, in other embodiments, the update interaction could occur within a text-based interface.

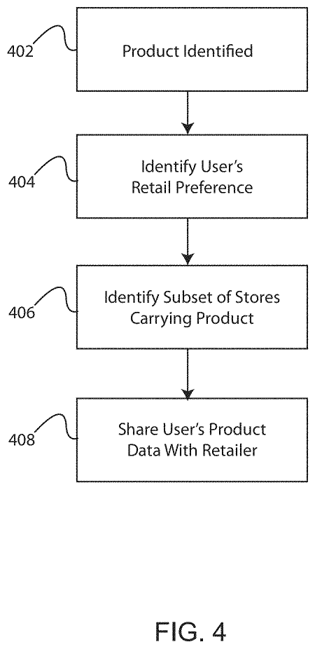

FIG. 4 illustrates a flowchart showing the steps utilized by the present invention to share data collected by the system with a retail or other supplying entity. At step 402, the system 200 identifies the product or content at issue. Next, at step 404 the system 200 will identify the user's retail preferences based on stored data derived from previous purchases by the same user. At step 406, the system 200 will identify a subset of stores carrying the product at issue (or the service, etc.). Lastly, at step 408, the system will share the user's preferences with the retailer that fits that categories derived from the user's past behavior.

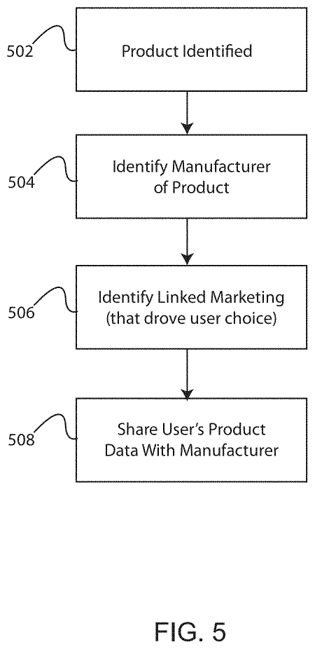

FIG. 5 illustrates a flowchart showing the steps utilized by the present invention to share data collected by the system with a manufacturer entity. At step 502, the system 200 identifies the product or content at issue. Next, at step 504 the system 200 will identify the manufacturer of the product at issue as used and interacted with by the same user. At step 506, the system 200 will identify the linked marketing that drove the user's choice and change in product (or service) choices). This information in conjunction with the actual product (or services itself) may be valuable information for the manufacturer. Lastly, at step 508, the system will share the user's preferences with the manufacturer as derived from the user's past behavior.

Based on the foregoing process and flowcharts, it will be apparent to one of skill in the art that the system of this invention will prioritize content to be added to a user's shopping list. For example, the system will include predefined and stored categories such as home products and pet supplies. Each of these categories may have sub-categories such as light bulbs and laundry products under the category of home products. Further, each of these sub-categories may include respective further defined categories such as specific 60-Watt light bulbs under the light bulb sub-category and soap and/or softener under the sub-category laundry products. Of course, each category and sub-category may have an unlimited number of further sub-categories depending on the detail and specificity require for each user and such categories may be broken down to details such as price, product size, color, manufacturer, country of origin, etc.

Based on the foregoing disclosure, it will be understood by those of skill in the art that the present invention provides a computer enabled system and method for prioritizing a product list through an interactive session with a digital assistant, the method comprised of creating a personal account that includes a product list with a digital assistant, enabling the digital assistant to add products based on updating content that can be captured by linked IoT enabled devices, categorizing the products on the product list, and sharing the changes with retailers and manufacturers. The method further comprises capturing content that is presented on a linked display, captured by a linked camera, or heard by a linked microphone and identifying the products captured when requested through the digital assistant using image or voice analysis.

The invention is further comprised of a product categorization tree that allows additional categories and sub-categories to be added by the system with or without user interaction, and the invention provides the ability to store the ranking of the product inside a category. An embodiment of the invention may also comprise an interactive digital interview between the user and the digital assistant to properly categorize and prioritize the product and/or service. The interview may include questions based on a decision tree.

One aspect of the present invention includes sharing a change in user's preference or product choice(s) with retailers and/or identifying an individual's typical shopping choice. Another aspect of the present invention includes sharing the change in user's preferences or product choice(s) with a manufacturer. Additionally, the invention may identify the source of the change of choice so that a retailer and/or manufacturer may understand how certain marketing efforts are succeeding or not succeeding.

This disclosure will now set forth several practical examples of the present invention in use, but these examples are not intended to be limiting; instead, these examples will assist in the understanding of the present invention. For new product replacement and old product deletion, the following example may be exemplary. Jeremy is watching the Super Bowl and sees a new advertisement for a specific laundry detergent. Jeremy asks a smart device to add that product to his favorites list. The smart device promptly replies with the comment that it's adding “Product X” to the favorites list and asks the user if Jeremy agrees with the current classification as laundry detergent. The smart device then asks, “should I delete your old laundry detergent already in your current favorites/product list?” Jeremy agrees and product is interchanged.

The following example will set forth an example where a product is added to a list and prioritized. Kulvir is watching the Super Bowl and sees a new advertisement for a new product breakfast cereal product he would like to try. He asks a smart device to add that product to his favorites list. The smart device promptly replies with the comment that it's adding “XYZ's Raisin Bran Crunch Breakfast Cereal” to the favorites list and asks the user if Kulvir agrees with the current classification as Breakfast Cereal. The smart device then asks, “should it make this the highest or lowest priority breakfast cereal in your current favorites/product list?” Kulvir agrees to the product being the highest priority the next time he wants breakfast cereal to be ordered.

The following example provides a product addition and user selection of an associated preference. Mike is watching the Super Bowl and sees a new advertisement for a new toothpaste product he would like to try called “ABC White Minty Breeze.” Mike asks the smart device to add that product to his favorites list. The smart device promptly replies with the comment that it's adding “ABC White Minty Breeze” to the favorites list and asks the user if they agree with its current classification as toothpaste. The smart device then asks, “should it make this the toothpaste of choice for Mike or his wife's toothpaste, or for his daughter's toothpaste, when adding it to Mike's shopping cart of current favorites/product list?” Mike agrees to the product being considered as “Mike's Toothpaste” preference next time he wants Mike's Toothpaste to be ordered via the smart device.

An example whereby a user preference is shared with a supply chain is set forth as follows. After Mike changes his favorite toothpaste, Amazon sells that information to his local Walmart where he normally shops. Walmart sees that many customers are looking at the new ABC White Minty Breeze toothpaste and increases their order from the distributor. In addition, Walmart uses this information to put up a display near the cash registers to take advantage of the new interest in the product. Similarly, after Mike changes his favorite toothpaste, that information, along with the metadata that influenced the change, is sold to the ABC dental division, which learns that the super bowl commercial is effective in changing customer interest in their product. This allows the manufacturer to optimize their marketing budget.

Again, it will be understood by those of skill in the art that the present invention provides a system and method to add and prioritize commercially available products to a favorite ordering list leveraging the NLP capabilities of listening devices where the additional products are captured through the listening device or linked IoT devices. The present invention further provides a system and method to share changes made to a favorite list of a consumer with a user's typical retailer, and it provides a system and method to share the source of a change to a favorite list with manufacturers to allow them to prioritize spending in their marketing budget and modify their production volumes.

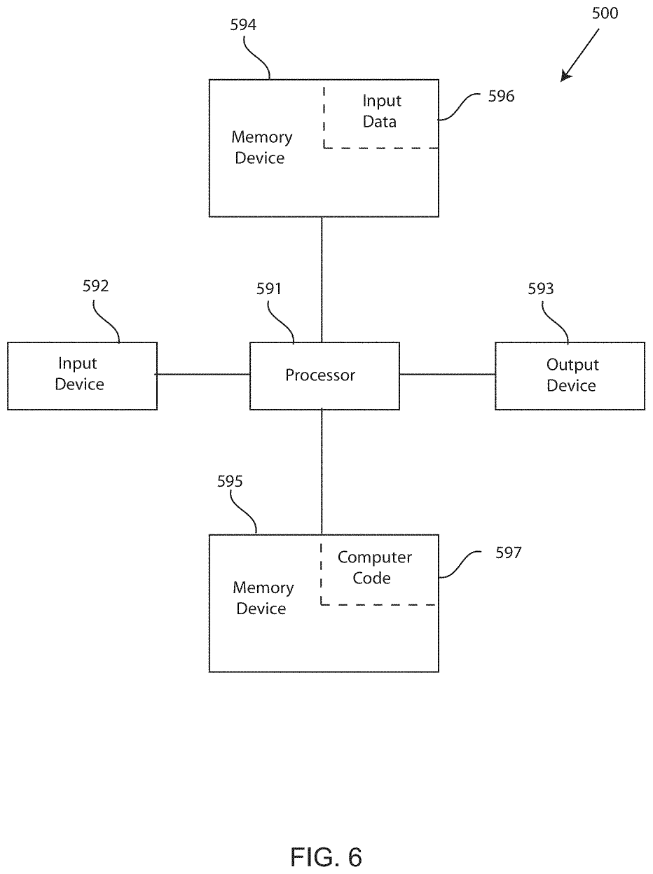

FIG. 6 illustrates a block diagram of a computer system for the system for adding and prioritizing products in a product list of FIGS. 1-2, capable of implementing methods for adding and prioritizing products in a product list of FIGS. 3-5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for adding and prioritizing products in a product list, in the manner prescribed by the embodiments of FIGS. 3-5 using the system for adding and prioritizing products in a product list of FIGS. 1-2, wherein the instructions of the computer code 597 may be executed by processor 591 via memory device 595. The computer code 597 may include software or program instructions that may implement one or more algorithms for implementing the methods for adding and prioritizing products in a product list, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 5.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to systems and methods for adding and prioritizing products in a product list. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to provide a system for adding and prioritizing products in a product list. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for adding and prioritizing products in a product list. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for adding and prioritizing products in a product list.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flow chart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flow chart and/or block diagram block or blocks.

The flow chart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

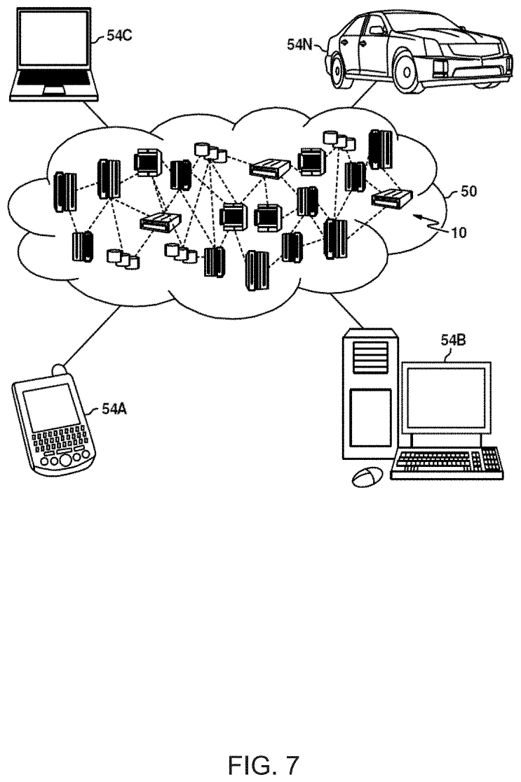

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

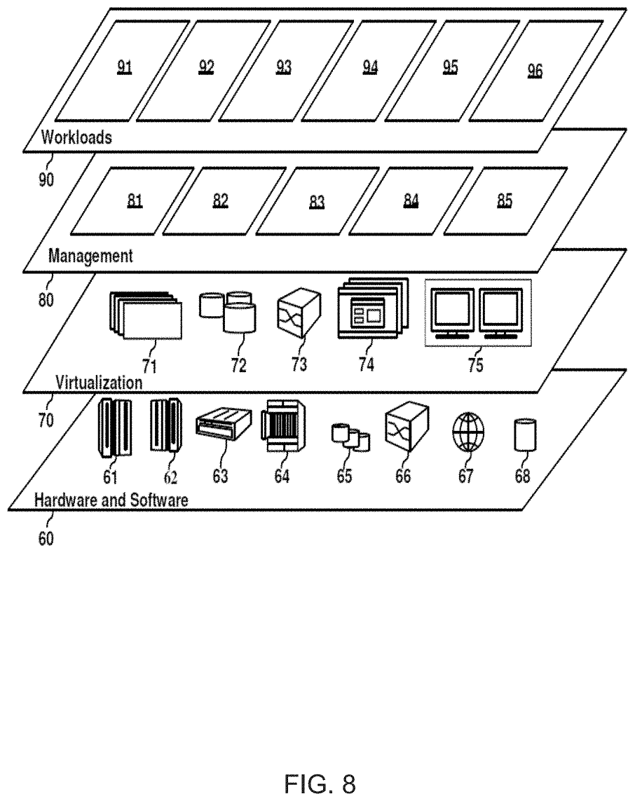

Referring now to FIG. 8, a set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and software module(s) 96.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

What is claimed is:

1. A method comprising:
identifying, by one or more processors of a computer system, a product using natural language processing capabilities of a listening device;
receiving, by the one or more processors of the computer system, an audible request to the listening device from a user to add the product to a product list; and
prioritizing, by the one or more processors of the computer system, the product within the product list based on a command from the user to the listening device using the natural language processing capabilities of the listening device.

2. The method of claim 1, further comprising:
identifying, by the one or more processors of the computer system, a similar product to the product located in the product list;
receiving, by the one or more processors of the computer system, confirmation from the user to substitute the product with the similar product; and
updating, by the one or more processors of the computer system, the product list by removing the product and adding the similar product.

3. The method of claim 1, further comprising:
determining, by the one or more processors of the computer system, product categories based on at least one of current categories in the product list or generic categories; and
classifying, by the one or more processors of the computer system, the product into at least one of the product categories using the natural language processing capabilities of the listening device.

4. The method of claim 1, further comprising associating, by the one or more processors of the computer system, the product with at least one user.

5. The method of claim 1, further comprising:
tracking, by the one or more processors of the computer system, changes made to the product list and metadata associated with products and changes within the product list; and
sharing, by the one or more processors of the computer system, the product list, the changes, and the metadata with at least one of a retailer or a manufacturer;
wherein the retailer and manufacture are chosen based on at least one of the location of the user or the products involved in the change to the product list.

6. The method of claim 5, wherein the metadata includes a marketing tool which prompted a change in the product list.

7. The method of claim 1, wherein the prioritizing includes an interactive dialogue between the user and the listening device utilizing the natural language processing capabilities of the listening device.

8. The method of claim 1, wherein the listening device is a virtual assistant.

9. A computer program product comprising:
a computer-readable storage device; and
a computer-readable program code stored in the computer-readable storage device, the computer readable program code containing instructions executable by a processor of a computer system to implement a method, the method comprising:
identifying, by one or more processors of a computer system, a product using natural language processing capabilities of a listening device;
receiving, by the one or more processors of the computer system, an audible request to the listening device from a user to add the product to a product list; and
prioritizing, by the one or more processors of the computer system, the product within the product list based on a command from the user to the listening device using the natural language processing capabilities of the listening device.

10. The computer program product of claim 9, the method further comprising:
identifying, by the one or more processors of the computer system, a similar product to the product located in the product list;
receiving, by the one or more processors of the computer system, confirmation from the user to substitute the product with the similar product; and
updating, by the one or more processors of the computer system, the product list by removing the product and adding the similar product.

11. The computer program product of claim 9, the method further comprising:
determining, by the one or more processors of the computer system, product categories based on at least one of current categories in the product list or generic categories; and
classifying, by the one or more processors of the computer system, the product into at least one of the product categories using the natural language processing capabilities of the listening device.

12. The computer program product of claim 9, the method further comprising associating, by the one or more processors of the computer system, the product with at least one user.

13. The computer program product of claim 9, the method further comprising:
tracking, by the one or more processors of the computer system, changes made to the product list and metadata associated with products and changes within the product list;
sharing, by the one or more processors of the computer system, the product list, the changes, and the metadata with at least one of a retailer or a manufacturer; and
wherein the retailer and manufacture are chosen based on at least one of the location of the user or the products involved in the change to the product list.

14. The computer program product of claim 13, wherein the metadata includes a marketing tool which prompted a change in the product list.

15. The computer program product of claim 9, wherein the prioritizing includes an interactive dialogue between the user and the listening device utilizing the natural language processing capabilities of the listening device.

16. A computer system, comprising:
a processor;
a memory coupled to said processor; and
a computer readable storage device coupled to the processor, the storage device containing instructions executable by the processor via the memory to implement a method, the method comprising:
identifying, by one or more processors of a computer system, a product using natural language processing capabilities of a listening device;
receiving, by the one or more processors of the computer system, an audible request to the listening device from a user to add the product to a product list; and
prioritizing, by the one or more processors of the computer system, the product within the product list based on a command from the user to the listening device using the natural language processing capabilities of the listening device.

17. The computer system of claim 16, the method further comprising:
identifying, by the one or more processors of the computer system, a similar product to the product located in the product list;
receiving, by the one or more processors of the computer system, confirmation from the user to substitute the product with the similar product; and
updating, by the one or more processors of the computer system, the product list by removing the product and adding the similar product.

18. The computer system of claim 16, the method further comprising:
determining, by the one or more processors of the computer system, product categories based on at least one of current categories in the product list or generic categories; and
classifying, by the one or more processors of the computer system, the product into at least one of the product categories using the natural language processing capabilities of the listening device.

19. The computer system of claim 16, the method further comprising:
tracking, by the one or more processors of the computer system, changes made to the product list and metadata associated with products and changes within the product list; and
sharing, by the one or more processors of the computer system, the product list, the changes, and the metadata with at least one of a retailer or a manufacturer;
wherein the retailer and manufacture are chosen based on at least one of the location of the user or the products involved in the change to the product list.

20. The computer system of claim 19, wherein the metadata includes a marketing tool which prompted a change in the product list.
